(19) United States
(12) Patent Application Publication
(10) Pub. No.: US 2015/0073822 A1
(43) Pub. Date: Mar. 12, 2015

(54) AUTOMATED SYSTEMS AND METHODS TO MANAGE COMPLIANCE OF CONTRACTS BETWEEN PROFESSIONALS AND THIRD PARTIES

(71) Applicant: Primacea, Inc., Andover, MA (US)

(72) Inventors: Steven J. Cagnetta, Winchester, MA (US); Steven Kif Ladd, Kennebunk, ME (US); David C. Horton, Mansfield, MA (US); David M. Duda, Holliston, MA (US)

(21) Appl. No.: 14/481,768

(22) Filed: Sep. 9, 2014

Related U.S. Application Data
(60) Provisional application No. 61/875,117, filed on Sep. 9, 2013.

(51) Int. Cl. G06Q 50/18; G06Q 50/22; G06Q 10/00

(52) U.S. Cl. CPC G06Q 50/18; G06Q 10/00; G06Q 50/22
USPC 705/2

(57) ABSTRACT

Systems, methods, and computer program product for managing contracts between professionals and organizations include providing online access to a proposed contract through a first online portal to a professional, who is a party to the proposed contract, and to a legal representative through an online legal portal. A review of the proposed contract, performed by the legal representative through the online legal portal, is guided in accordance with predefined criteria. Certain data extracted from the proposed contract by the legal representative are recorded in a database through the online legal portal.

### RELATED APPLICATION

This application claims the benefit of and priority to co-pending U.S. provisional application No. 61/875,117, filed Sep. 9, 2013, titled “Systems and Methods to Manage Compliance in Real-Time,” the entirety of which application is incorporated by reference herein.

### FIELD OF THE INVENTION

This invention relates generally to automated systems and methods for managing contracts between professionals and third parties.

### BACKGROUND

Many professionals, including those in medicine, law, accounting, and securities, are subject to extensive statutory, regulatory, and ethical rules that proscribe their behavior in order to protect best interests of society and their clients. In particular, physicians play a vital role in patient care, in developing new drugs and medical devices and in informing colleagues and the public in medical advancements. Because of the importance, scale, and cost of healthcare, relationships between physicians and hospitals, medical schools, medical societies, and industry have been under increasingly intense scrutiny.

Many laws have been put in place to not only ensure public trust in these relationships and the medical system as a whole, but also to control the expenditure of public funds. The laws, which include the Federal Food, Drug, and Cosmetic Act, Prescription Drug Marketing Act, False Claims Act (FCA), Civil Monetary Penalties Law (CMPL), Stark and Anti-Kickback Statute (AKS), regulate medical product manufacturing and marketing, require accurate Medicare and Medicaid billing, outlaw bribery and prohibit physicians from referring patients to entities in which they have certain financial interests. Most recently, the Physician Payment Sunshine Act provisions of the Patient Protection and Affordable Care Act require medical companies to report in detail virtually every financial exchange with physicians. This reporting will be through the CMS National Physician Payment Transparency Program (OPEN PAYMENTS).

Government investigators, prosecutors, legislators, regulators, ethicists, public policy advocates, medical societies, and medical schools have raised questions relating to physician-hospital contracts, physician consulting and speaking for industry, and physician leadership roles in medical societies and publications. These questions may turn into allegations of wrongdoing in cases where physicians have been paid significant sums of money for limited hours of work; in these cases, the allegations hold that the payments were for prescribing the products of payors rather than for providing legitimate services at fair market value (FMV).

Inattention in managing these physician relationships can lead to costly consequences. Fines typically total in the billions of dollars each year, defense expenses are significant, and negative publicity can lead to serious loss of reputation by physicians, their employers, and businesses. Large-scale violations of laws, regulations, hospital procedures, medical society rules and industry codes of conduct can be attributed to widespread utilization of ad-hoc processes for managing physicians' contractual relationships. Ad-hoc processes have resulted in missing, unsigned and expired contracts; inaccurate time and expense records; payments in excess of fair market value (FMV); off-label marketing of drugs and devices; violations of Stark self-referral, Anti-Kickback and insider trading laws; contracting of physicians who have lost their medical licenses and/or have been debarred; and violations of conflict-of-interest and conflict-of-commitment policies of medical institutions and societies.

Today, physicians often enter into contracts without legal representation and review; many often sign contracts without even reading them. Hospitals typically allow their physicians to enter into outside contractual relationships, often with little or no review of the relationships. As a result, physicians may agree to unreasonable liabilities, inappropriate compensation, restrictions on their relationships, loss of intellectual property rights, and violations of hospital and medical school policies. Additionally, use of the name and resources of a hospital may not be properly protected.

Today, once engagements are underway, time and expenses are often tracked “informally.” Professionals, including accountants, attorneys and physicians, often review their calendars, phone records and emails monthly, or even annually, to determine how much time to invoice against their engagements. Invoices, frequently produced with word processing systems, are often generated well after services are delivered; companies and professional societies report waiting several months to more than a year to receive invoices. Payments are often received and deposited into a bank account without being tracked in any way, and may not be reported after the payor sends the payee an IRS Form W-9. Such disorganized invoicing and payment reporting may subject physicians and their hospitals to potentially embarrassing publicity concerning such payments to physicians.

### SUMMARY

In one aspect, the invention features a method of managing contracts between professionals and organizations. The method comprises providing online access to a proposed contract through a first online portal to a professional, who is a party to the proposed contract, and to a legal representative through an online legal portal. A review of the proposed contract, performed by the legal representative through the online legal portal, is guided in accordance with predefined criteria. Certain data extracted from the proposed contract by the legal representative are recorded in a database through the online legal portal.

In another aspect, the invention features an online system for managing contracts between professionals and organizations. The online system comprises a computer system that provides online access to a proposed contract through a first online portal to a professional, who is a party to the proposed contract, and to a legal representative through an online legal portal. A processor is programmed to guide a review of the proposed contract by the legal representative through the online legal portal in accordance with predefined criteria and to record in a database certain data extracted from the proposed contract by the legal representative through the online legal portal.

In still another aspect, the invention features a computer program product for managing contracts between healthcare professionals and organizations. The computer program product comprises a computer readable persistent storage medium having computer readable program code embodied therewith. The computer readable program code comprises computer readable program code configured to provide, if executed, online access to a proposed contract to the healthcare professional, who is a party to the proposed contract, through an online physician portal, and to a legal representative through an online legal portal. The computer readable program code further comprises computer readable program code configured to guide, if executed, a review of the proposed contract performed by the legal representative through the online legal portal in accordance with predefined criteria, and computer readable program code configured to record, if executed, in a database certain data extracted from the proposed contract by the legal representative through the online legal portal.

### BRIEF DESCRIPTION OF THE DRAWINGS

The above and further features and advantages may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a system diagram of an embodiment of a real-time compliance system.

FIG. 2 is a system diagram of an embodiment of a web browser system of the real-time compliance system of FIG. 1.

FIG. 3 is a system diagram of an embodiment of a web server system of the real-time compliance system of FIG. 1.

FIG. 4 is a system diagram of an embodiment of a compliance processing system of the real-time compliance system of FIG. 1.

FIG. 5 is a system diagram of an embodiment of a portal system of the compliance processing system of FIG. 4.

FIG. 6 is a system diagram of an embodiment of a legal system of the compliance processing system of FIG. 4.

FIG. 7 is a system diagram of an embodiment of a data import system of the compliance processing system of FIG. 4.

FIG. 8 is a system diagram of an embodiment of an accounting system of the compliance processing system of FIG. 4.

FIG. 9 is a system diagram of an embodiment of a content repository of the compliance processing system of FIG. 4.

FIG. 10 is a system diagram of an embodiment of a report system of the compliance processing system of FIG. 4.

FIG. 11 is a system diagram of an embodiment of an audit system of the compliance processing system of FIG. 4.

FIG. 12A, FIG. 12B, and FIG. 12C comprise a flowchart of an embodiment of a process for managing contractual relationships of physicians with hospitals and other enterprises.

### DETAILED DESCRIPTION

Systems and methods described herein facilitate the management of relationships among professionals (e.g., physicians), employers (e.g., hospitals), and third-party enterprises by (1) ensuring compliance with laws and institutional policies, (2) providing an integrated legal review process with automatic reminders to help prevent incomplete documentation, (3) recording time and expenses in a timely and accurate manner, (4) producing invoices and tracks payments correctly, (5) using data generated by professionals in contracting, invoicing and recording payments to automatically populate compliance databases for employers, (6) generating accurate compliance reports that are available in real-time to professionals and their employers, and (7) auditing self-reported records in comparison with third-party data. An employer, as used herein, is generally an entity that pays for the services of a professional in whatever capacity the professional performs such services, whether as an employee, consultant, researcher, or independent contractor. An employee, as used herein, is generally an individual who directly or indirectly performs services for, and receives payments for such services from, an employer.

In brief overview, the described systems and methods facilitate legal, compliance, and fair market value reviews of professional engagements by multiple parties. Engagements start when written contracts are agreed upon and signed by all affected parties. Further, engagements end when such written contracts have expired. These engagement-related contracts are stored in a manner to be accessible to the various parties. In addition, professionals (e.g., physicians) can use such systems and methods to record and report, timely and accurately, all activities and activity-related expenses in connection with such engagements. Reminders of time and deliverables due against engagements are sent to the various parties so that, among other things, payments represent fair market value for time spent and deliverables completed. Moreover, invoices may be automatically generated from contract details, activity records and compliance categories, and payments to professionals timely and accurately reported. Although described herein, predominantly with reference to physicians, healthcare professionals, and medical institutions, the principles of the compliance system apply to other types of professionals and entities, for example, university professors and universities.

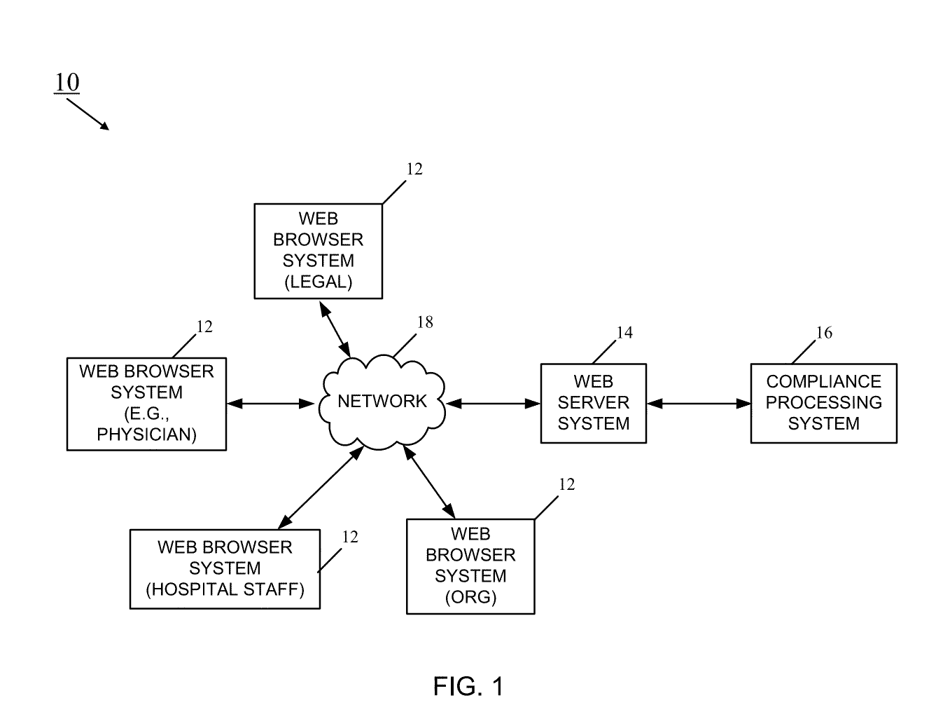

FIG. 1 shows an embodiment of a real-time compliance system 10 including a plurality of web browser systems 12 in communication with a web server system 14 and a compliance processing system 16 over a network 18. Embodiments of the network 18 include, but are not limited to, local-area networks (LAN), metro-area networks (MAN), and wide-area networks (WAN), such as the Internet or World Wide Web. Each web browser system 12 can connect to the web server system 14 over the network 18 through one of a variety of connections, such as standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g), 802.11(n)). For purposes of illustrating the principles described herein, a healthcare professional (e.g., physician) accesses the web server system 14 through one web browser system 12, a legal representative through another web browser system 12, hospital personnel through a third web browser system 12, and organizational personnel through a fourth web browser system 12.

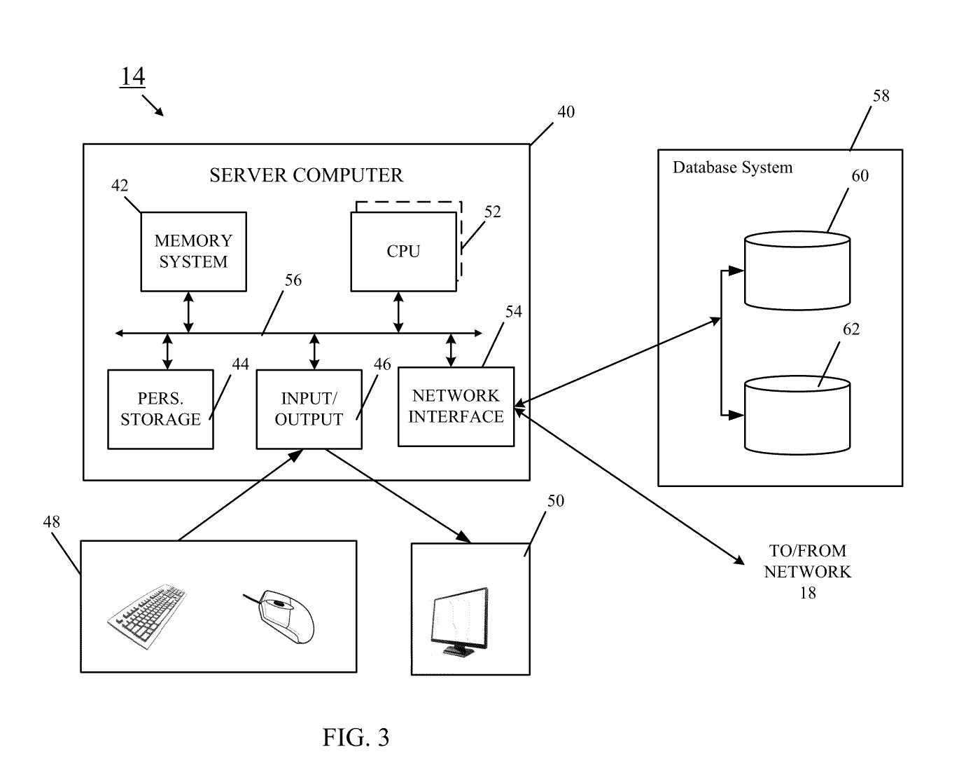

The web server system 14 is in communication with the compliance processing system 16 through software executing on a computer system 40, as described in more detail in connection with FIG. 3. Although shown separate from the web server system 14, the compliance processing system 16 may be part of the web server system 14 or running on another computer system. Some embodiments may not have the web server system 14. For example, the web browser system 12 can be integrated with the compliance processing system 16 (i.e., the software providing the compliance processing system 16 resides on a computer system of the web browser system 12 or on computer system coupled to the web browser system).

All transfers of data over the network 18 may use Secure Sockets Layer (SSL) technology with enhanced 128-bit encryption. Encryption certificates can be purchased from respected certificate authorities such as Symantec® of Mountain View, Calif. and Thawte® of Cape Town, South Africa, or can be generated by using any of the various commercially available key generation tools, many of which are available as open source. Alternatively, data may be transferred over a non-secure network, but in a less secure manner.

During typical operation, the web browser system 12 receives and transmits user inputs to the web server system 14 and receives and displays system outputs from the web server system 14 over the network 18. The web server system 14 transmits user inputs to and receives system outputs from the compliance processing system 16.

In brief overview, the compliance processing system 16 handles legal, accounting, reporting and auditing functions in a defined manner, managing received data in accordance with a predetermined scheme. The compliance processing system 16 may comprise several modules. These modules can be part of a distributed architecture consisting of several independent processes, data repositories, and databases that communicate and pass messages to each other through defined standard and proprietary interfaces. The independent processes of the compliance processing system 16 can facilitate scalability and throughput. Alternatively, each module may a logical entity of the same single process, without departing from the principles described herein.

In addition, the compliance processing system 16 supports multiple different relationship types and processes, from dozens to millions of transactions daily for tens to thousands of users in different markets. The compliance processing system 16 can utilize one or more servers hosted in a secure data center so that documents and transactions from healthcare, financial and other applications are processed in accordance with security policies that protect personally identifiable information and are compliant with privacy laws such as Health Insurance Portability and Accountability Act (HIPAA) and Gramm-Leach-Bliley Act (GLB).

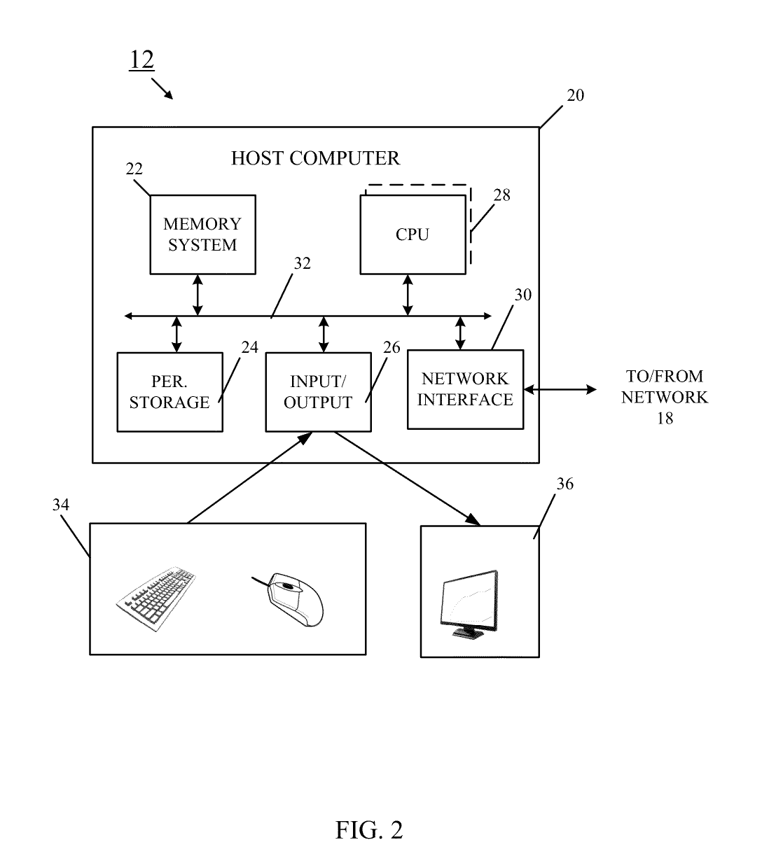

FIG. 2 shows an embodiment of the various components of the web browser system 12. This example of the web browser system 12 may include a host computer system 20 having a memory system 22, a persistent storage memory 24, an input/output interface 26, one or more central processing units (CPU) 28, and a network interface 30 connected to one or more signal busses 32. Example implementations of the computer system 20 include, but are not limited to, personal computers (PC), Macintosh computers, workstations, laptop computers, kiosks, network terminals, and hand-held devices, such as a personal digital assistant (PDA) and a BlackBerry™ cellular phones, smart-phones, and tablets.

The memory system 22 includes non-volatile computer storage media, such as read-only memory (ROM), and volatile computer storage media, such as random-access memory (RAM). Although shown as a single unit, the memory system 22 may include a plurality of units or modules, of various speeds and different levels (e.g., cache). Typically stored in the ROM is a basic input/output system (BIOS), which contains program code for controlling basic operations of the computer system 20 including start-up of the device and initialization of hardware. Stored within the RAM are program code and data. Program code includes, but is not limited to, application programs, program modules (e.g., browser plug-ins), and an operating system (e.g., Windows 95®, Windows 98®, Windows NT 4.0®, Windows XP®, Windows 2000®, Linux®, and Macintosh®, Apple IOS®, and Android®). Application programs include, but are not limited to, browser software, for example, Chrome®, Firefox®, Internet Explorer®, and Safari®, and a web application that produces an online portal through which the user of the host computer 20 can access content maintained by the compliance processing system 16. As used herein, the term “online” relates to accessing the content maintained by and functionality provided by the compliance processing system 16 over a network (e.g., network 18, the Internet, LAN).

The persistent storage device 24 may be fixed or removable storage memory, examples of which include hard disk drives, floppy drives, tape drives, removable memory cards, USBs, and optical storage.

Over wire or wireless links, the I/O interface 26 is in communication with one or more user-input devices 34 by which a user can enter information and commands and one or more output devices 36, such as a display, printer, and speaker. Examples of user-input devices 34 include, but are not limited to, a keyboard, a mouse, trackball, touch-pad, touch-screen, microphone, and a joystick.

The network interface 28 can be implemented with a network interface card (NIC) by which the computer system 20 is in communication with the network 18. The CPU 28 is representative of a single central processing unit (CPU), multiple CPUs, or a single CPU having multiple processing cores. The CPU 28 executes program code stored in the memory system 22 automatically upon system start-up or in response to user-supplied commands. The signal bus 32 carries signals to and from the various components of the computer system 20. Exemplary implementations of the signal bus 32 include, but are not limited to, a Peripheral Component Interconnect (PCI) bus, an Industry Standard Architecture (ISA) bus, an Enhanced Industry Standard Architecture (EISA) bus, and a Video Electronics Standards Association (VESA) bus. Although shown as a single bus 32, it is to be understood that the various components may use multiple busses for internal communication, and that all components are not necessarily connected to any one given bus.

FIG. 3 shows an embodiment of the web server system 14 comprising a server computer 40 having a memory system 42, a persistent storage memory 44, an I/O interface 46 in communication with input devices 48 and output devices 50, one or more processing units (CPU) 52, and a network interface 54 in communication over a high-speed bus 56. The various components of the server computer 40 can be implemented in similar fashion as the corresponding components of the host computer 20 described in connection with FIG. 2.

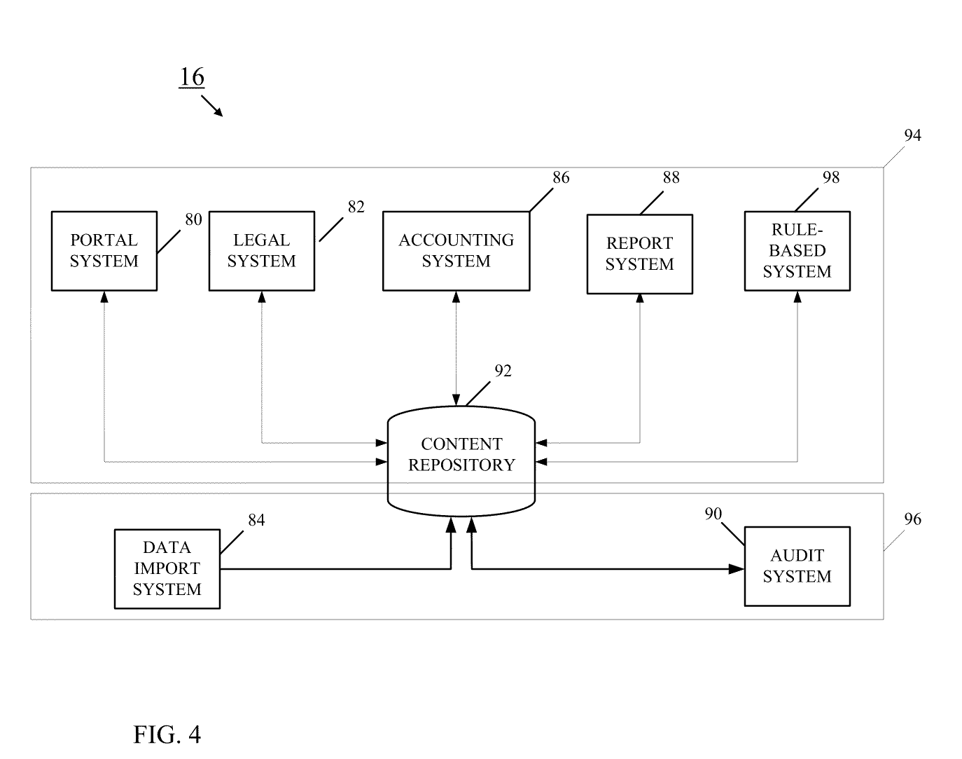

The web server system 14 also includes a database system 58 comprised of database 60 and database 62. Databases 60 and 62 make up the content repository 92 of the compliance processing system 16 shown in FIG. 4. (The terms “database” and “data repository” and “content repository” may be used interchangeably herein). The server computer 40 is in communication with the database system 58 through the network interface 54 using, for example, a gigabit Ethernet connection.

Although shown in FIG. 3 to be separate from the database system 58, some or all of the databases 60, 62 may be housed within the server computer 40. The various programmatic processes may be executed on a single computer, as shown in FIG. 3, or they may be distributed across multiple computers.

The network interface 54 of the server system 40 provides a connection to the network 18 through which to communicate with the web browser system 12. Data transfers over the network 18 can use Secure Sockets Layer (SSL) technology with enhanced 128-bit encryption. Web services running on the server system 40 can include, but not be limited to, Apache®, IBM® Websphere®, RedHat® JBoss® Web Server, Microsoft® IIS, and Oracle® iPlanet® Web Server. The web service provided by the web server system 14 is adapted to handle multiple HTTP or HTTPS requests in a secure manner from different users who are using their web browser systems 12 to access the compliance processing system 16 through the web server system 14.

FIG. 4 shows an example embodiment of the compliance processing system 16 including a portal system 80, a legal system 82, a data import system 84, an accounting system 86, a report system 88, an audit system 90, and a rule-based system 98, each of which is in communication with a content repository 92. In one embodiment, the portal system 80, legal system 82, accounting system 86, report system 88, and rule-based system 98 are in communication with content repository 92 by a first software module 94, and the data import system 84 and audit system 90 are in communication with content repository 92 by a second software module 94.

In brief overview, the portal system 80 provides access to portions of the compliance processing system 16 to authorized users, such as physicians, legal representatives and other types of representatives, and hospital administrators, university professors, and universities. Through the portal, such users can enter and retrieve the various types of information described herein including the profile of professionals. As used herein, a profile of a professional is a set of information about the professional. Examples of information about the professional include, but not are limited to, personal data, research and collaboration activities of, contracts entered by, payments received by, time spent on a contract by, the professional.

Each portal presented to a given individual (professional, representative) or institution is customized for that particular individual or institution. For example, a given physician has access, through a physician portal and his or her own account, confidential information pertaining to that physician, but to no other physicians. A medical institution has access, through a hospital portal and its own account, to information, including confidential and proprietary information, of each physician employed by that medical institution, but not to that of physicians employed by other medical institutions. Examples of medical institutions, as used herein, include, but are not limited to, hospitals, physician organizations, physician practices, medical schools, contract research organizations, research institutions, and other medical-related institutions.

Similarly, each university has access, through a university portal, to information, including confidential and proprietary information, of each professional educator employed by that university, but not to that of professional educators employed by other universities. Examples of institutions of higher learning include, but are not limited to, universities and colleges. Individuals, such as physicians, doctors, higher-level educators, may be referred to generally as professionals. Parties, such as hospitals, medical schools, universities, colleges, may be referred to generally as entities.

The legal system 82 manages contract logging, contract review, contract approval and communications between users of the compliance processing system 16, such users include contracting parties or reviewing parties. The data import system 84 imports and processes third-party databases and compliance-related records. The accounting system 86 manages the recording of time, expenses and deliverables, invoicing, collections, payments, and other accounting-related transactions. The report system 88 generates real-time compliance reports in the form of documents or dynamic web pages. The audit system 90 compares user-provided data with third-party information; and the report system 88 can generate a report of the results of the comparison. The content repository 92 stores all the data for the compliance processing system 16.

The rule-based system 98, in general, automatically applies one or more rules to information in a profile of a professional accessed by an employer, to determine whether the professional is in compliance with requirements of the employer. The criteria for determining compliance can widely vary from employer to employer. In general, compliance is assessed with respect to amount of payments received by the professional, amount of time spent by the professional on a contract or research and collaboration activity, and the identity of organizations for who the performs the service or activity. Examples of rules that may be applied include, but are not limited to, limiting a professional to no more than 52 days consulting with outside entities per year; restricting professionals from receiving payments in excess of $25,000 for any particular contract; requiring professionals to notify the employer within 30 days of receipt of $5,000 or more in compensation and expense reimbursement from any of a particular set of entities, restricting professionals from contracting with an entity in a specified set of entities; and restricting professionals from accepting compensation in excess of $5,000 per day.

In general, the content repository 92 is a generic application “data store” that can be used for storing both text and binary data (e.g., word processor documents, PDFs, images, videos). One feature of the content repository 92 is that storage format for the data is transparent to the users of the real-time compliance system 10; for example, the data can be stored in a relational database (RDBMS), or a file system, or as an XML document, or any combination thereof. In addition to providing services for storing and retrieving the data, the content repository 92 may provide advanced services, including, but not limited to, uniform access control, searching, versioning, observation, and locking.

The content repository 92 can be a simple file system, a relational database, an object oriented database, any other persistent storage system or technology, or a combination of one or more of these. In one embodiment, the content repository 92 is based on MongoDB®, which is an open-source document database written in C++. MongoDB® features document-oriented storage of JSON-style documents with dynamic schemas; full index support on any attribute; replication and high availability by minoring across LANs and WANs; auto-sharding that scales horizontally without compromising functionality; rich, document-based queries; fast in-place updates that utilize atomic modifiers for contention-free performance; flexible aggregation and data processing; storage of files of any size without stack complications.

Documents in the content repository 92 are available to end users of the compliance system 10 through the portal system 80. For example, a user can click on a document link in their web browser and view the original document over a secure network. In effect, the content repository 92 serves as an off-site secure storage facility for electronic documents of the compliance system 10.

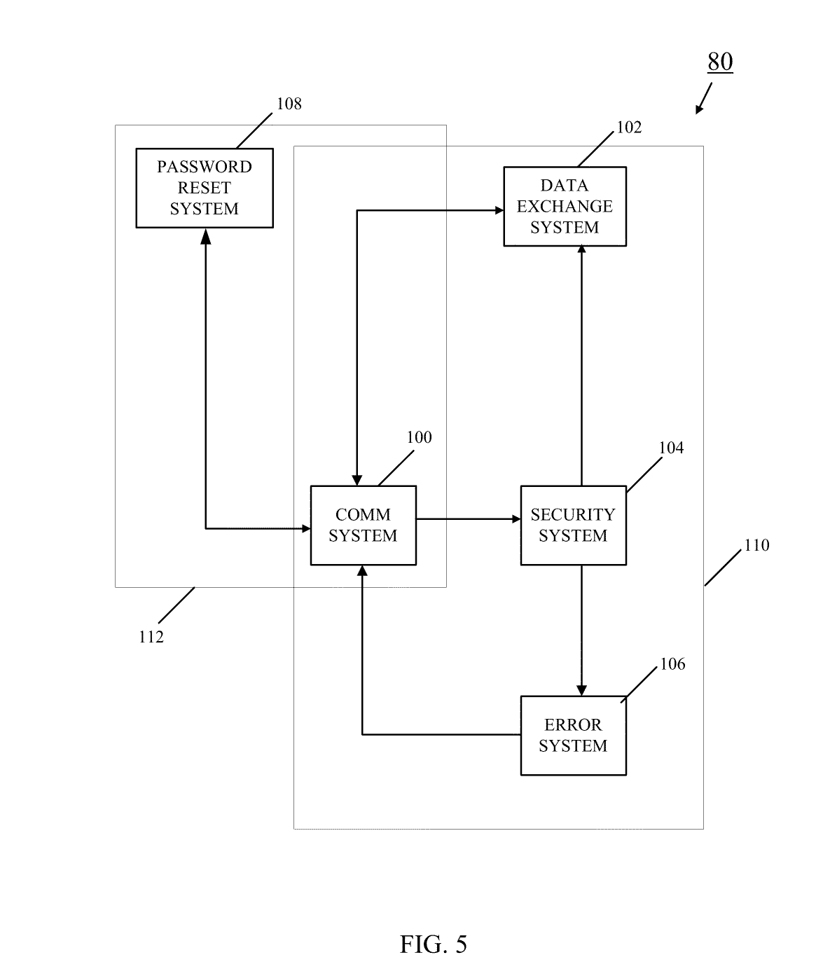

FIG. 5 shows an embodiment of the portal system 80 of FIG. 4 including a communication (comm) system 100, a data exchange system 102, a security system 104, an error system 106, and a password reset system 108. In one embodiment, a first software module 110 connects the comm system 100, the data exchange system 102, the security system 104, and the error system 106; and a second software module 112 connects the comm system 100 and the password reset system 108

During typical operation, the comm system 100 communicates with the web server system 14. The data exchange system 102 provides access to portions of the compliance processing system 16 with authorization from the security system 104. The security system 104 compares the user identification and password to a set of valid user identifications and passwords, and communicates with the data exchange system 102 and the error system 106. The error system 106, when executed, returns a login error message to the comm system 100. The password reset system 108 provides users a mechanism for changing passwords.

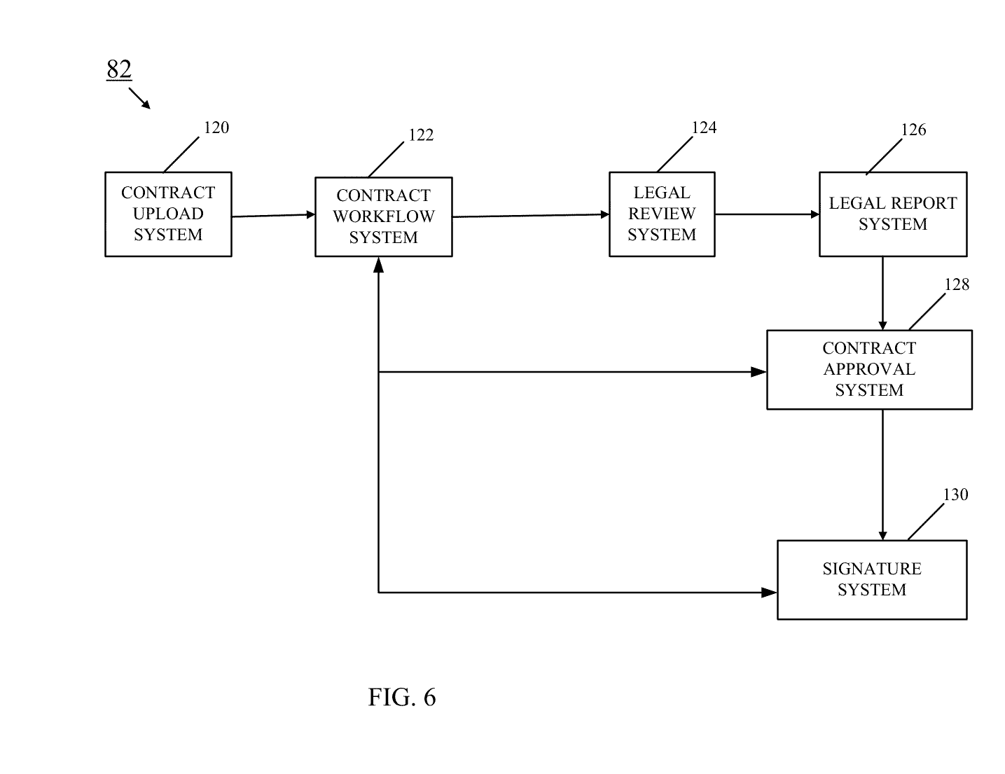

FIG. 6 shows an embodiment of the legal system 82 of FIG. 4 including a contract upload system 120, a contract workflow system 122, a legal review system 124, a legal report system 126, a contract approval system 128, and a signature system 130. In one embodiment, software provides the communications among the contract upload system 120, the contract workflow system 122, the legal review system 124, the legal report system 126, the contract approval system 128, and the signature system 130.

When executed, the contract upload system 120 receives new and revised contracts for legal review. The contract workflow system 122 manages contract review and approval by various users by sequencing the operations performed by the contract upload system 120, the legal review system 124, the contract approval system 128, and the signature system 130; and by notifying and reminding users when their interactions with legal personnel are needed. The legal review system 124 facilitates the structured review of contract elements and potential contract concerns. The legal report system 126 formats the results produced by the legal review system 124 into standardized reports and electronic communications. The contract approval system 128 provides users processes by which to review, comment on, propose changes to and approve contracts. The signature system 130 provides users processes by which to execute contracts using electronic signatures and file uploads. The signature system 130 also provides a process for confirming the presence of required signatures and that enters the date of last signature.

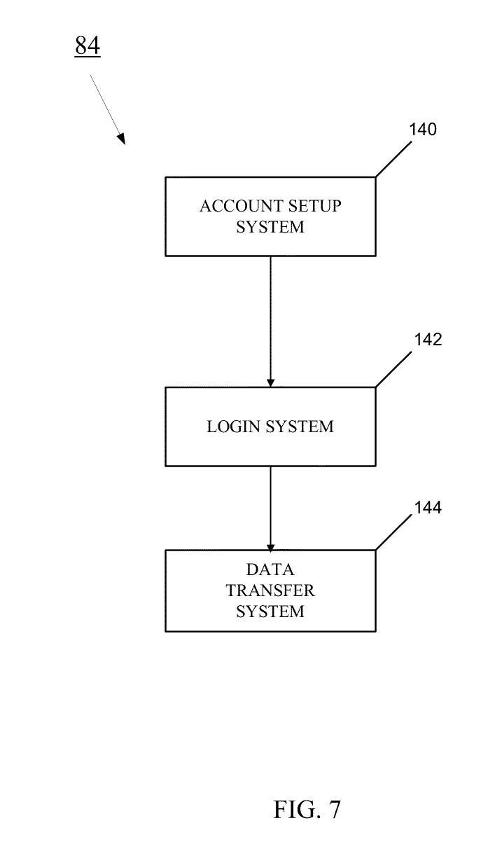

FIG. 7 shows an embodiment of the data import system 84 of FIG. 4 including an account setup system 140, a login system 142 and a data transfer system 144. Software provides the communications among the account setup system 140, the login system 142, and the data transfer system 144. In general, the data import system 84 operates in a similar manner as various cloud-based financial and document retrieval systems offered by software-as-a-service (SaaS) providers such as Yodlee®, Fiserv®, Intuit®, BankLink®, and FetchThis®.

When executed, the account setup system 140 communicates with third-party databases, such as the Open Payments (Sunshine Act) system. The account setup system 140 establishes the user identification and credentials needed to access and use third-party databases. The login system 142 establishes a connection with third-party databases. The login system 142 provides the user identification and credentials needed to access third-party databases. The data transfer system 144 retrieves data from and sends data to third-party databases. The data transfer system 144, for example, downloads payments data associated with the users logged in to the Open Payments system. The data transfer system 144 uploads disputed transaction data associated with the users logged in to the Open Payments system.

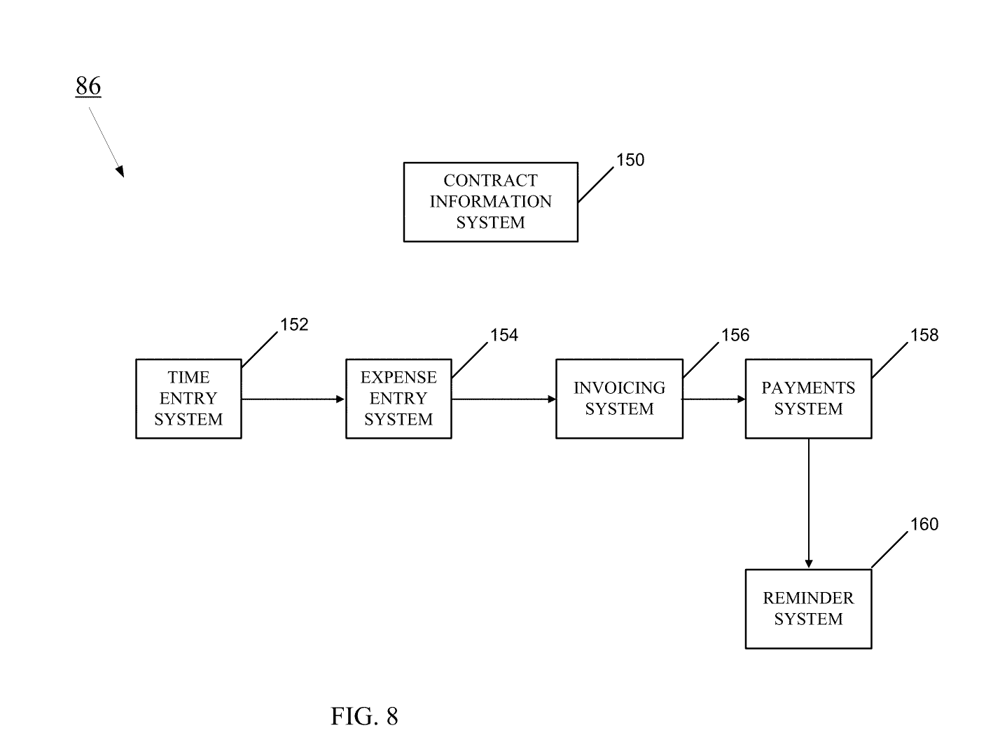

FIG. 8 shows an embodiment of the accounting system 86 of FIG. 4 including a contract information system 150, a time entry system 152, an expense entry system 154, an invoicing system 156, a payments system 158 and a reminder system 160. Software implements the communications among the contract information system 150, the time entry system 152, the expense entry system 154, the invoicing system 156, the payments system 158, and the reminder system 160; the software modules may be collectively or individually implemented as an interactive web application and a mobile application that enable the physician to enter data into the content repository 92 (FIG. 4). The accounting system 86 does not require users to do any setup or customization; the accounting system 86 configures charts of account, customer lists, types of income and expenses, billing rates, invoicing styles and report formats automatically by utilizing internal rules and data extracted by the legal review system 124 (FIG. 6).

During operation, the contract information system 150 provides legal representatives a means to record contract details that are used by the accounting system 86. The contract information system 150 provides the means for setting up and customizing the accounting system 86 by a third party other than a physician user. The time entry system 152 provides users a means to record properly categorized time spent on engagement-related activities. The expense entry system 154 provides users a means to record engagement-related expenses in a timely and accurate manner. The invoicing system 156 enables users to produce invoices automatically and to format payment reports for various compliance systems, such as those required by particular hospitals, healthcare systems, universities, funding organizations and medical societies. The payments system 158 provides users a means to record and track the receipt of engagement-related payments. The reminder system 160 reminds users on a periodic basis to make entries in the accounting system 86, for example, sending reminders to a physician to record payments received into the accounting system 86. Recording a received payment by a professional into the accounting system 86 changes the profile of the professional (the payment becomes information associated with the profile of the professional). In one embodiment, the reminder system 160 provides users with daily and weekly summaries of entries by the users in the accounting system 86 along with links to make additional entries. In addition, the reminders issued by the reminder system 160 can take the form of email reminders that include to links to a particular web application and the mobile application that supports the particular form of data entry sought for from the physician (e.g., a reminder to record a payment can include a link to the payments system 158).

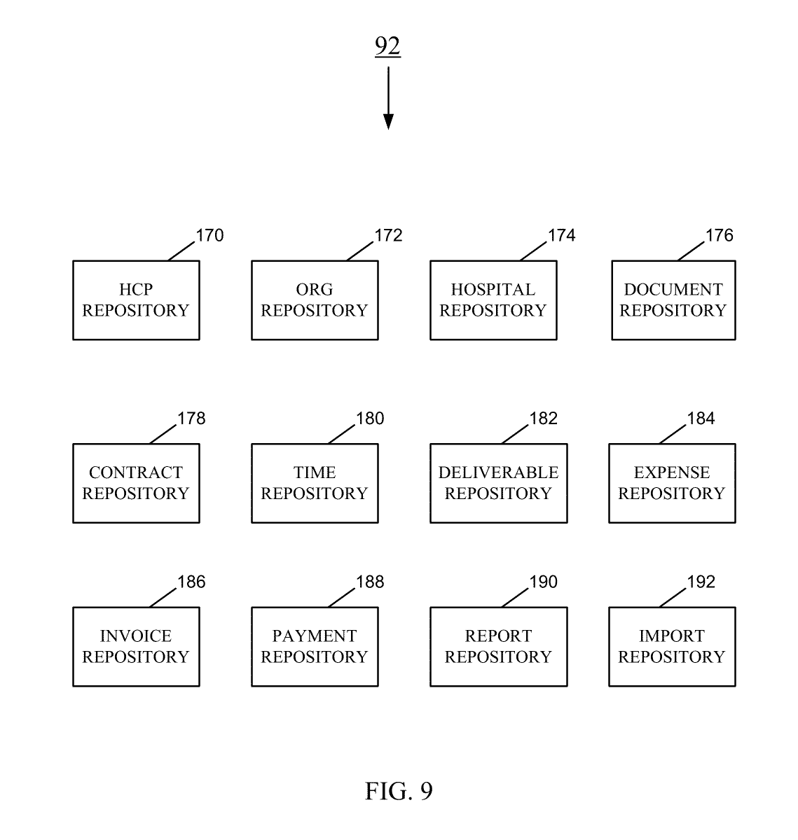

FIG. 9 shows an embodiment of the content repository 92 of FIG. 4 including an HCP repository 170, an ORG repository 172, a hospital repository 174, a document repository 176, a contract repository 178, a time repository 180, a deliverable repository 182, an expense repository 184, an invoice repository 186, a payment repository 188, a report repository 190, and an import repository 192. Software provides access to the various repositories of the content repository 92.

During operation, the HCP repository 170 stores data about physicians and other healthcare professionals. For each healthcare professional, the HCP repository 170 includes the name, previous name (if any), nickname (if any), salutation, gender, birth date, social security number (SSN), driver's license number, driver's license state, type of healthcare professional, National Provider Identifier (NPI), home address, home phone number, work address, work phone number, cell phone number, email address, hospital position, hospital department, hospital supervisor, hours worked per week, board specialty, board organization, medical license number, medical license state, fellowship, internship, medical school, and medical degree.

During operation, the ORG repository 172 stores data about organizations, such as businesses, universities, contract research organizations, publishers, medical societies and medical education organizations that engage physicians. For each organization, the ORG repository 172 includes the organization name, organization contact name, organization contact address, organization contact phone number, organization contact email, organization homepage, and organization parent.

During operation, the hospital repository 174 stores data about hospitals and related organizations. For each hospital, the ORG repository 174 includes the hospital name, hospital compliance contact name, hospital compliance contact address, hospital compliance contact phone number, hospital compliance contact email, hospital compliance documents, and hospital compliance rules. The hospital repository can be automatically populated with such information.

During operation, the document repository 176 stores documents, such as signed contracts, invoices, and reports, and the contract repository 178 stores contract-related data entered by legal representatives. For each contract, the contract repository 178 includes a healthcare professional, organization, original contract, modified contracts, contract name, engagement purpose, start date, end date, early termination by healthcare professional, early termination by organization, renewal allowed, renewal days before termination, invoicing frequency, expense reimbursement terms, maximum invoicing, payment terms, equity compensation, equity type, equity shares, equity price per share, equity vesting time, equity vesting period, equity time credited, equity vesting cliff, equity vesting cliff period, equity exercise time, equity exercise period, equity exercise event, equity acceleration terms, equity acceleration percentage, equity grant FMV, royalty products, royalty percent, royalty time, and royalty period.

For each activity in each contract, the contract repository 180 includes the activity type, activity name, activity description, work rate, work rate period, work rate maximum, work rate maximum period, work rate minimum, work rate minimum period, travel rate, travel rate period, travel rate maximum, travel rate maximum period, travel rate minimum, travel rate minimum period, deliverable name, deliverable description, deliverable deadline.

Under normal operation, the time repository 180 stores time data entered by physicians. For each entry, the time repository 180 includes time (in hours), date, task, and note.

Under normal operation, the deliverable repository 182 stores deliverable data entered by physicians. For each entry, the deliverable repository 182 includes time (in hours), deliverable type, deliverable quantity, date, task, and note.

Under normal operation, the expense repository 184 stores expense data entered by physicians. For each entry, the expense repository 184 includes cost, date, engagement, note, type of expense (airfare, auto mileage, bus, car rental, education, lodging, meals, other, parking, postage and freight, subway, taxi, tips, tolls, train and travel agent fees), and receipt image.

Under normal operation, the invoice repository 186 stores invoices created on behalf of physicians. For each entry, the invoice repository 186 includes the healthcare professional, organization, invoice number, invoice date, invoice amount, invoice due date, and invoice image (in Adobe PDF format). For each line item in each invoice, the invoice repository 186 includes a date, item type, item explanation, quantity, rate, and amount.

During typical operation, the payment repository 188 stores payments received by physicians. For each entry, the payment repository 188 includes a date, amount, discount amount, and invoice.

During normal operation, the report repository 190 stores reports generated for physicians. For each entry, the report repository 190 includes a report type, physician, report start date, report end date, and report image (in Adobe PDF format).

Under typical operation, the import repository 192 stores data imported from third-party databases. Each third-party database has its own content and format. As an example, the import repository 192 includes, in the case of Open Payments data, an organization identifier, physician name, physician business address, physician specialty, physician National Provider Identifier (NPI), date of payment, context (purpose of work associated with payment), related covered drug, device, biological or medical supply, form of payment (cash, in-kind, ownership interest, other), nature of payment (consulting fees, compensation for services other than consulting, honoraria, gift, entertainment, food, travel (including the specified destinations), education, research, charitable contribution, royalty or license, current or prospective ownership or investment interest, direct compensation for serving as faculty or as a speaker for a medical education program, grant, any other nature of the payment or other transfer of value), and amount of payment.

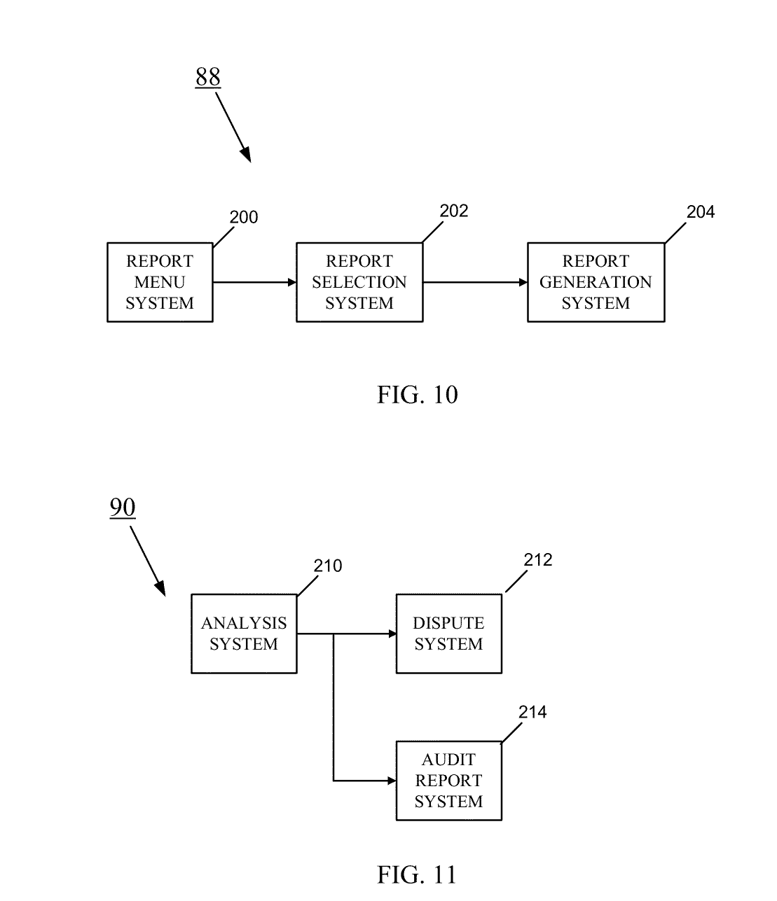

FIG. 10 shows an embodiment of the report system 88 including a report menu system 200, a report selection system 202, and a report generation system 204. Software connects these components of the report system 88. In general, the report system 88 enables users (e.g., a physician, hospital personnel, legal representative) to generate automatically real-time reports of, for example, activities, payments and conflicts-of-interest, using real-time data, and in a variety of formats, based on contract details (i.e., engagements) and payment records stored in the content repository 92 (FIG. 9).

When executed, the report menu system 200 presents a choice of reports to users as a function of the type of user. The report selection system 204 allows the user to select from a specific report from the list of available reports and to customize the report parameters such as date range, minimum and maximum value, and sorting order. The report generation system 204 generates reports per user-specified selections and parameters.

For example, through the report system 88, physicians can generate reports on their time, invoices, receivables, and payments. Hospitals can generate reports on the time spent by physicians over a specified date range, on the payments received by physicians over a specified date range, and on the payments made by organizations over a specified date range. In addition, hospital personnel can see the details of each individual payment that is made by an organization to a physician.

As another example, hospital personnel can run a report that produces a research and collaboration report (may also be referred to as a conflict-of-interest report) for a given physician. Today, physicians typically prepare conflict of interest reports from memory, often in the year following the activities and payments being reported. Additionally, physicians often report the time that they spend on their various responsibilities, such as administrative, clinical and research work, on a quarterly or annual basis; these reports are often “estimated” on a quarterly or annual basis. This leaves physicians and their hospitals vulnerable to the consequences of inaccurate and incomplete reporting. The reporting system 88 enables the hospital to dynamically produce a research and collaboration report based on the information added to the content repository related to the physician (e.g., new active contracts or engagements). Each research and collaboration activity included in a report had the identity of an organization, and one of more of a role of the physician in, a purpose of, and a type of compensation received by the physician for participating in, that research and collaboration activity. The content included in a research and collaboration report depends on the information currently associated with the profile of the physician. Changes to the information associated with a profile results in a research and collaboration report upon the next occurrence of a query of the content repository.

In addition, the query of the content repository to produce research and collaboration reports can be filtered by selected criteria, for example, received payment amounts and time spent. The hospital can generate this report through an online hospital portal. Alternatively, the reporting system 88 can automatically produce such a research and collaboration report in response to a browser user traversing to a web site of the physician.

FIG. 11 shows an embodiment of the audit system 90 of FIG. 4 including an analysis system 210, a dispute system 212 and an audit report system 214. Such components of the audit system 90 communicate with each other through software. In general, the audit system 90 supports pre-publication auditing of self-reported activities and payments in comparison with proposed and published third-party databases, including, for example, physician payment entries in the Open Payments (i.e., Sunshine Act) database. Professionals (e.g., physicians) and authorized entities (e.g., hospitals) are able to view these payment comparisons. This auditing enables the resolution of disputes, if any, of payment entries in such third-party databases, preferably before such third-party databases become public.

During operation, after the data import system 84 (FIG. 4) sets up accounts on behalf of physicians, and then uses these accounts to automatically download records from a third-party database, one physician at a time. The analysis system 210 compares physician-entered data with information obtained from the third-party databases and with compliance guidelines. For example, the physician can acquire payment information from a third-party database that reflects what the third party considers to have paid the physician, and the analysis system 210 can flag discrepancies between the payment as understood and entered by the physician and the third-party database.

The dispute system 212 enables physicians (professionals, in general) to view, challenge, and explain information flagged by the analysis system 210. The audit report system 214 generates reports that show deviations in user-entered data with information in third-party databases and compliance guidelines. The physician-supplied information can be presented alongside the third-party database information, allowing the physician or other party, such as an administrator or other member of a medical institution employing the physician, to easily review the third-party information in light of the information entered by the physician. The dispute system 212 permits the physician to selectively enter corrections to the information in the third-party database, and to communicate the corrections to a third-party database. Corrections may be submitted, for example, through an application-programming interface (API) or through a web interface.

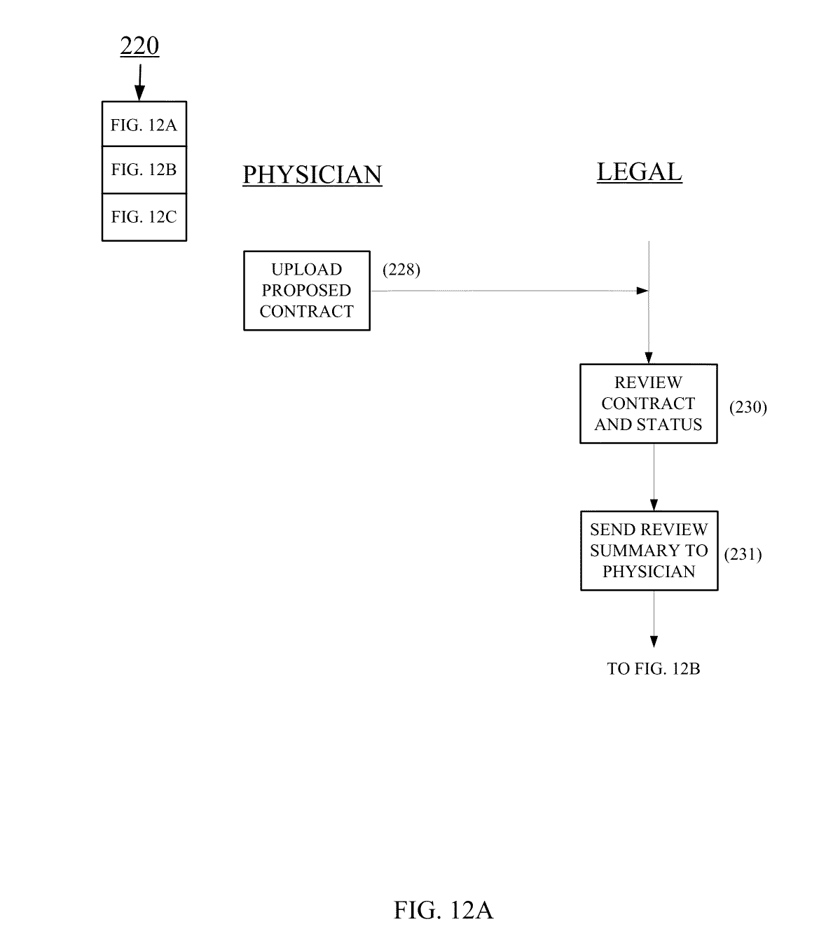

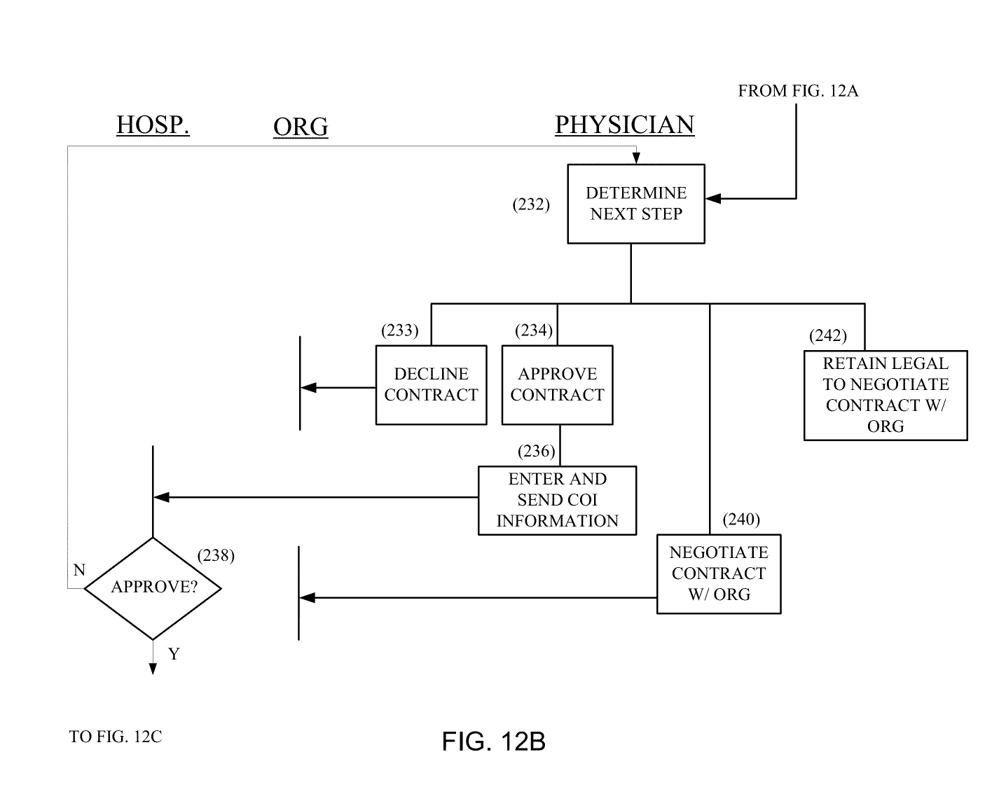

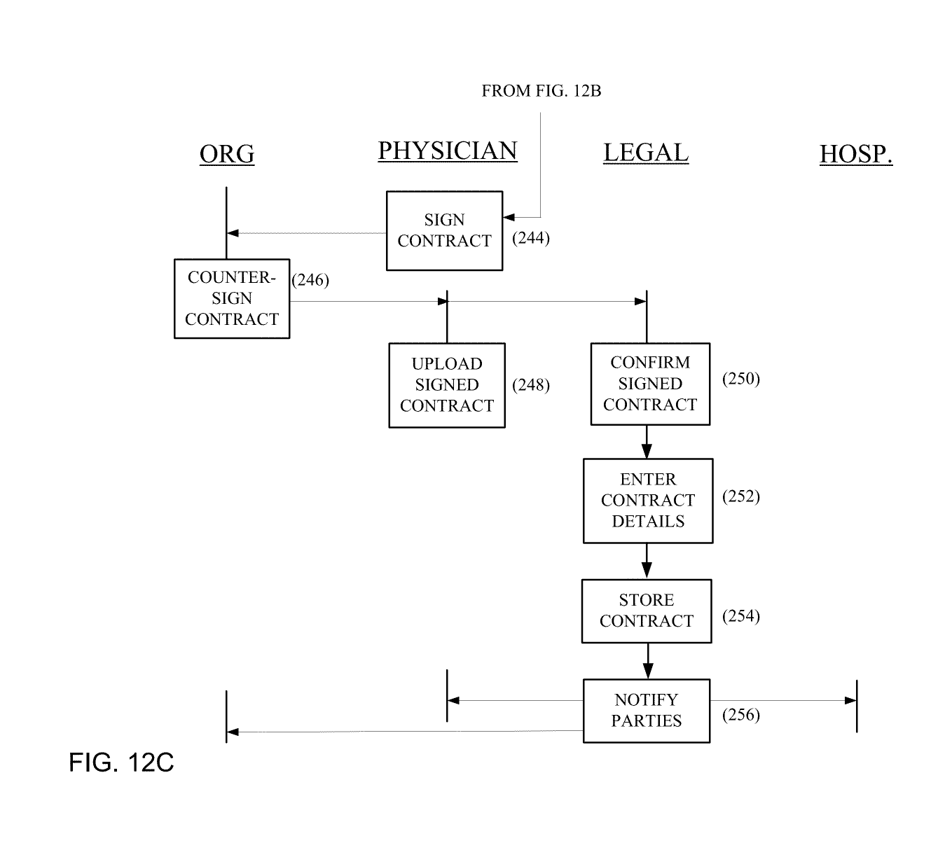

FIG. 12 shows an embodiment of a process 220 corresponding to a workflow for managing the contractual relationships of physicians with enterprises and hospitals. The management of such relationships is needed to ensure legal and ethical compliance. Before contracts are signed, potential relationships should be vetted, contract terms analyzed and all requirements (such as conflict of interest reporting, physician background screening, fair market value analysis and compliance training) should be in place. During the engagements, deliverables, time, expenses and receipts must be tracked; invoices and payments should be managed; contract terms (such as time spent, results to be achieved and contract termination dates) should be administered and physician responsibilities, including training and conflict-of-commitment, should be supervised. Periodically and/or after engagements are completed, contract-related information should be audited or verified and reports generated and shared with appropriate constituencies. Given the number and complexity of the contractual relationships of physicians, both inside and outside the hospital setting, a formal system with minimal manual processes facilitates replacement of the ad-hoc, error-prone processes in place today. The process 220 integrates a legal review of proposed engagements and amendments to engagements into the establishing and management of health professional relationships.

In the description of the process 220, reference is made to the various elements described in FIG. 1 through FIG. 11. Consider, as a starting point for describing the process 220, that a proposed contract resides in the contract repository 178 (FIG. 9) of the content repository (FIG. 4), awaiting action from the physician (i.e., healthcare professional). From a host computer (or device) 20, the physician activates a web application (mobile device application), and logs in into his or her account (if not already logged in). The portal system 80 (FIG. 5) of the compliance processing system 16 ensures the physician is an authorized user. After successfully logging in, the portal alerts the physician to a pending contract requiring attention. The portal can notify the physician of other events or activities, for example, a reminder to submit an invoice or an upcoming deadline.

The physician uploads (step 228) the draft contract to the content repository 92 for subsequent analysis and review (step 230) by a legal representative. The contract upload system 120 (FIG. 6) uploads the accepted contract to the contract repository 178. When the contract is uploaded, the contract workflow system 122 (FIG. 6) notifies the legal representative that the contract is ready for review. The portal produced by the portal system 80 on the host computer 20 of the legal representative alerts the legal representative of the availability of the uploaded documents. Alternatively, the legal representative may receive an email or text message to check the legal portal for the proposed contract. The portal of the legal representative includes a dashboard containing all applicable activities for that legal representative, including new agreements (i.e., contracts, engagements) for review, agreements in the review process, reminders of pending action items, copies of all physician correspondences, access to physician folders, form provisions and documents and copies of relevant laws, regulations and hospital policies. (The terms “agreements”, “contracts”, and “engagements” may be used interchangeably herein.) The contract workflow system 122 (FIG. 6) may send automated reminders to the legal representative to take action in the event no action has been taken on a given contract after a customizable period.

With each proposed contract or engagement, the legal representative receives an automatically generated review sheet provided by the legal review system 124. The legal representative uses the review sheet to (1) review the documents of the proposed engagement from the perspective of certain potential legal and publicity risks to the physician and to the physician's hospital, (2) analyze the proposed compensation versus the fair market value (FMV) of the physician, and (3) check compliance with federal and state laws and compliance with hospital policies (including limits on the types of work to be done, the time spent on particular matters and the compensation proposed under the engagement). The legal representative also reviews the contract for terms that may be unfavorable to client (e.g., non-compete clauses, assignment of intellectual property rights, indemnification clauses). The review sheet may identify such types of clauses to prompt the legal representative to be particularly alert for such clauses in the proposed contract. In addition, this review sheet may be displayed in the legal portal, and require the legal representative to supply or acknowledge certain information before the review process can successfully terminate.

In one embodiment, the compliance processing system 16 computes the FMV of the physician based on the profile of the physician stored in the HCP repository 170. In the computation of the FMV, the compliance processing system 16 can weigh various data about the physician differently, for example, giving more weight to the number of years in active practice than to the particular medical school attended. Other factors for assessing the FMV of the physician may include, but not be limited to, the number of publications, the hospital position, the board specialty, and the number of hours worked during the week. The centralized role played by the legal representative serves to standardize and update the review of legal risks, standardize responses to specific issues, and standardize tracking of legal and regulatory requirements and of a customizable set of hospital rules.

At step 230, the legal representative reviews the contract and its status. Through the portal, the legal representation signifies that the legal review is complete, and the legal report system 126 automatically generates and sends (step 231) a notification (e.g., email, text message) to the physician that includes a summary of the engagement, a list of issues and choices as to courses of action. The summary of the engagement may include much of the information added to the portal by the legal representative. The results of the document review of the legal representative, including the review summary and critical data, may be stored in a standardized format (e.g., document repository 176 (FIG. 9)). The legal review system 124 also stores legal markups of the documents (e.g., document repository 176 (FIG. 9)). In one embodiment, each legal markup is a document in Adobe® PDF or Microsoft® Word® format.

When again the physician visits the physician portal, the portal displays an alert indicating that the contract has returned from the legal representative and is awaiting action by the physician. With a single click (i.e., activation on a link or button from an input device 34), the physician can select (step 232) the next step in negotiating the contract. In one embodiment, the contract approval system 128 presents four choices in the physician portal (any one of which can be selected with the single click). One, the physician can decline the contract outright; two, accept the contract as written; three, forward the documents of the contract (possibly marked up) to the organization (i.e., other party to the contract) for review and negotiation of the open terms of the contract directly with the organization; and four, request that the legal representative be engaged to negotiate the terms of the contract with the organization on behalf of the physician.

When the physician chooses the first option to decline the contract, the contract approval system 128 sends (step 233) an automated, fully drafted email message that notifies the appropriate representative of the organization that the physician has declined the contract. The physician has the option of editing the email before contract approval system 128 sends it. A copy of the email message that is sent. The contract approval system 128 sets the status of the engagement to “declined.”

When the physician chooses the second option to accept the contract, the contract workflow system 122 presents (step 234) the physician with an electronic form requesting disclosure information required by the appropriate hospital, for example, a conflict-of-interest questionnaire (an example of a disclosure form). After the physician completely enters all the required information, the contract approval system 128 sends (step 236) a message to the applicable compliance personnel of the hospital of the physician indicating that the physician wants to accept the engagement. In one embodiment, the contract approval system 128 presents a fully drafted email message that can be edited by the physician along with a copy of all legal documents and the summary of the engagement. The contract approval system 128 stores a copy of the message sent.

Through the portal presented to the hospital compliance personnel, the contract approval system 128 provides a one-click means for the hospital compliance personnel to approve or reject the engagement (step 238). In one embodiment, the hospital compliance personnel sends an addendum to be executed by the physician as a condition to the hospital approving the proposed contract. The contract workflow system 122 provides reminders to the hospital compliance personnel to take action in reviewing the engagement in the event no action has been taken after a customizable period.

If the hospital compliance personnel reject the engagement, the contract approval system 128 sends a message to the physician and to the legal representative. The message includes an optional set of reasons for the rejection of the engagement. The message also includes an optional set of conditions to change the rejection to an approval. The contract approval system 128 sends the message to the physician and the legal representative, and stores a copy of the message. The contract approval system 128 permits the physician to revise the initial choice to accept the engagement to one of the three alternate choices: decline the engagement, negotiate changes directly or retain the legal representative to negotiate on behalf of the physician.

If, instead, the hospital compliance personnel approve the engagement, the contract approval system 128 sends a corresponding message to the physician and to the legal representative. The contract approval system 128 stores a copy of the message that is sent and sets the status of the engagement to “approved.”

When the physician chooses the third option to negotiate the contract with the organization, the contract approval system 128 sends (step 240) an email that notifies the appropriate representative of the organization that the physician has had the engagement documents reviewed by legal counsel and that the physician wishes to change certain terms proposed for the engagement. In one embodiment, the contract approval system 128 presents a fully-drafted email message that can be edited by the physician along with the summary of the engagement and the marked up documents, and stores a copy of the message that is sent along with all attachments to the message.

When the physician chooses the fourth option to retain the legal representative to negotiate the contract with the organization, the contract approval system 128 provides (step 240) the physician with a legal engagement letter of the legal representative. In one embodiment, the signature system 130 enables the physician to electronically sign the legal engagement letter. Alternately, the signature can be provided by conventional method of printing, manually signing, scanning and uploading the legal engagement letter to the content repository 92. The contract workflow system 122 stores a copy of the signed legal engagement letter and notifies the legal representative that the legal representative has been retained to negotiate on the physician's behalf. The contract workflow system 122 provides reminders to the legal representative to take action in negotiating the engagement in the event no action has been taken after a customizable period.

The negotiations brought about by the selecting of the third or fourth option can lead to one or more iterations of revising, uploading the current draft of the contract, presenting to the legal representative, and presenting to the hospital compliance personnel for approval, and renegotiating, as described in steps 228 through 242, until the engagement is eventually declined or approved.

After a decision is made to approve the contract, whether resulting from the selection of the second option or after renegotiations resulting from the selection of the third or fourth options, the signature system 130 may convert all engagement documents into a single approved engagement document in Adobe PDF format and send (step 244) the engagement document to the physician for execution. The signature system 130 may enable the physician to electronically sign the approved engagement document using an e-signature provider, such as Adobe EchoSign®, DocuSign®, RightSignature®, Sertifi® and SignNow®. Alternatively, the signature can be provided by conventional method of printing, manually signing, scanning and uploading the signed approved engagement document. The contract workflow system 122 stores a copy of the physician-signed approved engagement document.

After obtaining the signature of the physician, the signature system 130 sends (step 246) an email to the organization with the physician-signed approved engagement document and instructions to return a signed version to the legal representative. Optionally, the contract workflow system 122 sends reminders to the organization to sign the approved engagement document in the event no action has been taken after a customizable period. The organization sends the countersigned contract to the physician and/or to the legal representative.

After receiving the fully executed engagement document from the organization, the legal representative (or physician) uploads (step 248) a scanned copy of the fully executed contract to the compliance processing system 16 using web browser functionality.

The legal representative confirms (step 250) whether the executed contract was properly signed. The legal review system 124 enables the legal representative to enter the date when the document was properly signed. After the signature is confirmed and the date entered, the contract approval system 128 sets the status of the engagement to “active”.

In addition, the legal representative enters (step 252) the details of the executed contract into the contract information system 150. In general, the legal representative manually records critical data used by the accounting system 86, particularly data relating to the business terms of the proposed engagement, including the name of the entity to which services are provided, the billing address and other contact information, type of services to be provided, the amount of compensation to be paid, the billing requirements, the payment terms and the term of the engagement. In an alternative embodiment, the contract information system 150 records the critical data by inputting electronic documents, performing optical character recognition (OCR) on document images, extracting the data, determining the nature of the data (for example, entity name, billing address, payment terms), and entering the data into the appropriate fields of the contract repository 178.

The contract is stored (step 254) in the contract repository 178. A copy of the stored contract is available to the physician, the legal representative, the hospital, and the organization through a portal. The contract upload system 82 adds the engagement to the active engagements list on the physician portal. Adding a new active contract changes the profile of the professional to include this new contract; similarly expired or inactive contracts also change the profile. The contract workflow system 122 notifies (step 256) the physician, the applicable hospital compliance personnel, and the organization that the engagement is active.

When a physician views his or her physician portal, a list of all active engagements is displayed. For each active engagement, the accounting system 86 enables the physician to record time, completed deliverables, and incurred expenses, to generate and send invoices, and to record received payments. Each recording of time spent on an activity, completed deliverables, incurred expenses, generated and sent invoices, and received payments by a physician operates to change the profile of the physician.

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

The computer readable medium may be a computer readable storage medium, examples of which include, but are not limited to, an electronic, magnetic, optical, electromagnetic, infrared, or semiconductor system, apparatus, or device, or any suitable combination thereof. As used herein, a computer readable storage medium may be any non-transitory, tangible medium that can contain or store a program for use by or in connection with an instruction execution system, apparatus, device, computer, computing system, computer system, or any programmable machine or device that inputs, processes, and outputs instructions, commands, or data. A non-exhaustive list of specific examples of a computer readable storage medium include an electrical connection having one or more wires, a portable computer diskette, a floppy disk, a hard disk, a random access memory (RAM), a read-only memory (ROM), a USB flash drive, an non-volatile RAM (NVRAM or NOVRAM), an erasable programmable read-only memory (EPROM or Flash memory), a flash memory card, an electrically erasable programmable read-only memory (EEPROM), an optical fiber, a portable compact disc read-only memory (CD-ROM), a DVD-ROM, an optical storage device, a magnetic storage device, or any suitable combination thereof. A computer readable storage medium can be any computer readable medium that is not a computer readable signal medium such as a propagated data signal with computer readable program code embodied therein.

Program code may be embodied as computer-readable instructions stored on or in a computer readable storage medium as, for example, source code, object code, interpretive code, executable code, or combinations thereof. Any standard or proprietary, programming or interpretive language can be used to produce the computer-executable instructions. Examples of such languages include C, C++, Pascal, JAVA, BASIC, Smalltalk, Visual Basic, and Visual C++.

Transmission of program code embodied on a computer readable medium can occur using any appropriate medium including, but not limited to, wireless, wired, optical fiber cable, radio frequency (RF), or any suitable combination thereof.

The program code may execute entirely on a user's computer, partly on the user's computer, as a stand-alone software package, partly on the user's computer and partly on a remote computer or entirely on a remote computer or server. Any such remote computer may be connected to the user's computer through any type of network, including a local area network (LAN) or a wide area network (WAN), or the connection may be made to an external computer (for example, through the Internet using an Internet Service Provider).

Additionally, the methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The methods illustrated herein however can be readily implemented in hardware and/or software using any known or later developed systems or structures, devices and/or software by those of ordinary skill in the applicable art from the functional description provided herein and with a general basic knowledge of the computer and image processing arts.

Moreover, the disclosed methods may be readily implemented in software executed on programmed general-purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a dedicated fingerprint processing system, as a plug-in, or the like. The system can also be implemented by physically incorporating the system and method into a software and/or hardware system, such as the hardware and software systems of an image processor.

While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents, and variations that are within the spirit and scope of this invention.

What is claimed is:

1. A method of managing contracts between professionals and organizations, the method comprising:
providing online access to a proposed contract through a first online portal to a professional, who is a party to the proposed contract, and to a legal representative through an online legal portal;
guiding a review of the proposed contract performed by the legal representative through the online legal portal in accordance with predefined criteria; and
recording in a database certain data extracted from the proposed contract by the legal representative through the online legal portal.

2. The method of claim 1, wherein the professional is a healthcare professional.

3. The method of claim 1, further comprising automatically generating a review sheet for guiding the review of the proposed contract by the legal representative.

4. The method of claim 1, wherein the predefined criteria include requiring the legal representative to analyze compensation proposed in the proposed contract versus a fair market value assessment of the professional.

5. The method of claim 1, wherein the predefined criteria include requiring the legal representative to review compliance of the proposed contract with a policy of an employer of the professional.

6. The method of claim 1, further comprising generating, by the legal representative, a report based on the review of the proposed contract, the report identifying key terms and any potential irregularity found in the proposed contract.

7. The method of claim 6, further comprising electronically receiving, by the professional in response to the professional choosing to accept the proposed contract in view of the report, a disclosure form of an employer of the professional.

8. The method of claim 7, further comprising:
electronically notifying a member of the employer that the professional wishes to accept the proposed contract after the disclosure form is completed; and
including, with the notification to the member of the employer, a copy of the proposed contract.

9. The method of claim 8, further comprising:
electronically receiving a decision from the employer to approve or reject the proposed contract; and
automatically electronically notifying the professional and the legal representative of the decision of the employer.

10. The method of claim 8, further comprising electronically sending, from the employer to the professional in response to the notification that the professional wishes to accept the proposed contract, an addendum to be executed by the professional as a condition to the employer approving the proposed contract.

11. The method of claim 1, further comprising:
storing a copy of the proposed contract in the database after the proposed contract is signed by the professional and an appropriate personnel of an organization who is a second party to the proposed contract;
electronically notifying the professional and appropriate parties that the proposed contract is active; and
electronically delivering the copy of the proposed contract to at least one of the professional, the legal representative, an employer of the professional, and the organization.

12. The method of claim 11, further comprising adding the proposed contract to an active contracts list on the first online portal, enabling the professional to perform at least one of recording time, recording deliverables, recording expenses, generating invoices, sending invoices, and recording payments, related to the proposed contract.

13. An online system for managing contracts between professionals and organizations, the online system comprising:
a computer system providing online access to a proposed contract through a first online portal to a professional, who is a party to the proposed contract, and to a legal representative through an online legal portal;
a processor programmed to guide a review of the proposed contract by the legal representative through the online legal portal in accordance with predefined criteria and to record in a database certain data extracted from the proposed contract by the legal representative through the online legal portal.

14. The online system of claim 13, wherein the professional is a healthcare professional.

15. The online system of claim 13, wherein the processor is further programmed to automatically provide a review sheet for guiding the review of the proposed contract by the legal representative.

16. The online system of claim 13, wherein the predefined criteria include requiring the legal representative to analyze compensation proposed in the proposed contract versus a fair market value assessment of the professional.

17. The online system of claim 13, wherein the predefined criteria include requiring the legal representative to review compliance of the proposed contract with a policy of an employer of the professional.

18. The online system of claim 13, wherein the processor is further programmed to generate a report based on the review of the proposed contract, the report identifying key terms and any potential irregularity found in the proposed contract.

19. The online system of claim 18, wherein the processor is further programmed to present through the first online portal, in response to the professional choosing to accept the proposed contract in view of the report, a disclosure form of an employer of the professional.

20. The online system of claim 19, wherein the processor is further programmed to:
notify a member of the employer that the professional wishes to accept the proposed contract after the disclosure form is completed; and
include, with the notification to the member of the employer, a copy of the proposed contract.

21. The online system of claim 20, wherein the processor is further programmed to:
receive, through a second online portal, a decision from the employer to approve or reject the proposed contract; and
automatically electronically notify the professional and the legal representative of the decision of the employer in response to receiving the decision.

22. The online system of claim 20, wherein the processor is further programmed to electronically send, from the employer to the professional in response to the notification that the professional wishes to accept the proposed contract, an addendum to be executed by the professional as a condition to the employer approving the proposed contract.

23. The online system of claim 20, wherein the processor is further programmed to:
store a copy of the proposed contract in the database after the proposed contract is signed by the professional and by an appropriate personnel of an organization who is a second party to the proposed contract;
electronically notify the professional and appropriate parties that the proposed contract is active; and
electronically deliver the copy of the proposed contract to at least one of the professional, the legal representative, an employer of the professional, and the organization.

24. The online system of claim 13, wherein the processor is further programmed to add the proposed contract to an active contracts list on the first portal, enabling the professional to perform at least one of recording time, recording deliverables, recording expenses, generating invoices, sending invoices, and recording payments related to the proposed contract.

25. A computer program product for managing contracts between healthcare professionals and organizations, the computer program product comprising:
a computer readable persistent storage medium having computer readable program code embodied therewith, the computer readable program code comprising:
computer readable program code configured to provide, if executed, online access to a proposed contract to the healthcare professional, who is a party to the proposed contract, through an online physician portal, and to a legal representative through an online legal portal;
computer readable program code configured to guide, if executed, a review of the proposed contract performed by the legal representative through the online legal portal in accordance with predefined criteria; and
computer readable program code configured to record, if executed, in a database certain data extracted from the proposed contract by the legal representative through the online legal portal.

26. The computer program product of claim 25, wherein the computer readable program code further comprises computer readable program code configured to generate automatically, if executed, a review sheet for guiding the review of the proposed contract by the legal representative.
The computer program product of claim 25, wherein the computer readable program code further comprises computer readable program code configured to electronically send, if executed, to the healthcare professional in response to a notification that the healthcare professional wishes to accept the proposed contract, an addendum to be executed by the healthcare professional as a condition to a medical institution, who employs the healthcare professional, approving the proposed contract.
